(19) United States
(12) Patent Application Publication
(10) Pub. No.: US 2020/0168963 A1
(43) Pub. Date: May 28, 2020

(54) ELECTRIC VEHICLE BATTERY CELL HEAT TRANSFER SYSTEM AND METHOD

(71) Applicant: SF Motors, Inc., Santa Clara, CA (US)

(72) Inventors: Scott Quinlan Freeman Monismith, Santa Clara, CA (US); Derek Nathan Wong, Santa Clara, CA (US); Ying Liu, Santa Clara, CA (US); Yifan Tang, Santa Clara, CA (US); Bin Bin Chi, Santa Clara, CA (US); Brennan Campbell, Santa Clara, CA (US)

(21) Appl. No.: 16/203,309

(22) Filed: Nov. 28, 2018

(51) Int. Cl. H01M 10/6551; H01M 2/30; H01M 2/02; H01M 2/04; H01M 2/10; H01M 10/625

(52) U.S. Cl. CPC H01M 10/6551; B60L 11/1879; B60L 11/1874; H01M 2/305; H01M 2/0237; H01M 2220/20; H01M 2/043; H01M 2/1072; H01M 10/625; B60L 2270/46; H01M 2/0262

(57) ABSTRACT

Provided herein is a heat transfer system for a battery cell of a battery pack of an electric vehicle. The heat transfer system can provide temperature regulation of battery cells disposed within a battery pack of an electric vehicle during charging of the respective battery cells or operation of the electric vehicle. A battery cell can include a housing with an electrolyte disposed in an inner region defined by the housing and a dual polarity lid. The heat transfer system can include a sleeve coupled with an outer surface of the housing. A cooling plate can couple with a second end of the housing. A plurality of fins can extend from the first surface of the cooling plate. The plurality of fins can be disposed around the battery cell and coupled with the sleeve to facilitate heat transfer between the battery cell, the plurality of fins and the cooling plate.

### BACKGROUND

Batteries can include electrochemical materials to supply electrical power to electrical components connected thereto. Such batteries can provide electrical energy to electrical systems.

### SUMMARY

At least one aspect is directed to a system. The system can include a heat transfer system for battery cells of battery packs to power electric vehicles. A battery cell of a battery pack to power an electric vehicle can be provided. The battery cell can include a housing having a first end and a second end. The housing can define an inner region. An electrolyte can be disposed in the inner region defined by the housing. A lid can couple with a first end of the housing. A sleeve can couple with an outer surface of the housing of the battery cell. A cooling plate can couple with the second end of the housing of the battery cell. The cooling plate can have a first surface and a second surface. A plurality of fins can extend from the first surface of the cooling plate. The plurality of fins can be disposed around the battery cell and coupled with the sleeve to transfer heat between the battery cell, the plurality of fins and the cooling plate.

At least one aspect is directed to a method of providing heat transfer for battery cells of battery packs to power electric vehicles. The method can include providing a battery pack having a battery cell. The battery cell can include a housing that include a first end and a second end and defines an inner region. The method can include disposing an electrolyte within the inner region. The method can include coupling a lid with the first end of the housing. The method can include disposing a sleeve around an outer surface of the housing of the battery cell. The method can include forming a cooling plate having a plurality of fins, and the cooling plate having a first surface and a second surface. The method can include coupling a battery cell with the first surface of the cooling plate such that the plurality of fins are disposed around the battery cell and coupled with the sleeve to transfer heat between the battery cell, the plurality of fins and the cooling plate, the plurality of fins extending from the first surface of the cooling plate.

At least one aspect is directed to a method. The method can include providing a battery cell of a battery pack to power an electric vehicle. The battery cell can include a housing having a first end and a second end. The housing can define an inner region. An electrolyte can be disposed in the inner region defined by the housing. A lid can couple with a first end of the housing. A sleeve can couple with an outer surface of the housing of the battery cell. A cooling plate can couple with the second end of the housing of the battery cell. The cooling plate can have a first surface and a second surface. A plurality of fins can extend from the first surface of the cooling plate. The plurality of fins can be disposed around the battery cell and coupled with the sleeve to transfer heat between the battery cell, the plurality of fins and the cooling plate.

At least one aspect is directed to an electric vehicle. The electric vehicle can include a battery cell of a battery pack to power the electric vehicle. The battery cell can include a housing having a first end and a second end. The housing can define an inner region. An electrolyte can be disposed in the inner region defined by the housing. A lid can couple with a first end of the housing. A sleeve can couple with an outer surface of the housing of the battery cell. A cooling plate can couple with the second end of the housing of the battery cell. The cooling plate can have a first surface and a second surface. A plurality of fins can extend from the first surface of the cooling plate. The plurality of fins can be disposed around the battery cell and coupled with the sleeve to transfer heat between the battery cell, the plurality of fins and the cooling plate.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a diagram depicting an exploded view of a battery cell for a battery pack of an electric vehicle and a heat transfer system, according to an illustrative implementation;

FIG. 2 is a block diagram depicting a battery cell for a battery pack of an electric vehicle coupled with a heat transfer system, according to an illustrative implementation;

FIG. 3 is a block diagram depicting multiple battery cells for a battery pack of an electric vehicle coupled with a heat transfer system, according to an illustrative implementation;

FIG. 4 is a diagram of a dual polarity lid for of a battery cell for a battery pack of an electric vehicle, according to an illustrative implementation;

FIG. 5 is a block diagram depicting a cross-sectional view of an example battery pack for an electric vehicle, according to an illustrative implementation;

FIG. 6 is a block diagram depicting a cross-sectional view of an example electric vehicle installed with a battery pack, according to an illustrative implementation;

FIG. 7 is a flow diagram depicting an example method of providing a heat transfer system for a battery cell of a battery pack to power an electric vehicle, according to an illustrative implementation; and

FIG. 8 is a flow diagram depicting an example method of providing a heat transfer system for a battery cell of a battery pack for an electric vehicle, according to an illustrative implementation.

### DETAILED DESCRIPTION

Following below are more detailed descriptions of various concepts related to, and implementations of battery cells for battery packs in electric vehicles. The various concepts introduced above and discussed in greater detail below can be implemented in any of numerous ways.

Systems and methods described herein relate to a heat transfer system for a battery cell of a battery pack of an electric vehicle. The heat transfer system can provide temperature regulation of one or more battery cells disposed within a battery pack of an electric vehicle during charging of the respective battery cells or operation of the electric vehicle. For example, the heat transfer system can provide passive or active cooling to the respective battery cells. The heat transfer system can include a cooling plate having a plurality of fins that extend from a first surface of the cooling plate. The cooling plate and the plurality of fins can be formed from thermally conductive material (e.g., aluminum) to facilitate the heat transfer from the respective battery cells to the cooling plate and fins. The plurality of fins can be organized in a plurality of fin arrangements to couple with and receive battery cells of a battery pack along a top surface of the cooling plate. For example, at least one battery cell can couple with or be disposed within a fin arrangement. The heat transfer system can include a sleeve disposed around an outer surface of the housing of the battery cells to aid in the heat transfer from the respective battery cells to the cooling plate and fins. Further, the additional aluminum material (aluminum mass) provided by the cooling plate and fins can provide increased resistance against compressive loading, improving a crashworthiness of the respective battery pack.

The arrangement of the fins along the top surface of the cooling plate can provide reduced or decreased inter-cellular spacing between the battery cells of a battery pack and thus, provide a higher energy density. For example, the battery cells can couple with the fin arrangements using less or no adhesive material, as used in traditional battery pack designs. Further, the fin arrangements can position and keep the respective battery cells in place to provide fixturing of the battery cells with reduced amounts of adhesive material. Thus, the spacing between each of the battery cells in the battery pack can be reduced by coupling the battery cells with the fin arrangements along the top surface of the cooling plate and more battery cells can be disposed within a battery pack for a higher energy density of the battery pack.

The battery cells as described herein can include a dual polarity lid having multiple layers of aluminum material and provide multiple terminals for coupling with a busbar of a battery pack of an electric vehicle. For example, at least two of the layers of the lid can provide terminals for the battery cell. A first polarity layer can correspond to a first polarity terminal for the battery cell and a second polarity layer can correspond to a second polarity terminal for the battery cell. The different polarity terminals can be isolation by at least one isolation layer. The different polarity layers provided at the same end, here the lid, of the battery cell can provide increased corrosion resistance and a stronger (lower) impedance weld with increased yield for both a positive and negative terminal of the battery cell. The dual polarity lid can provide for the housing of the battery cell to be formed from non-electrically conductive material (e.g., non-polarized) material. Thus, the non-polarized battery cell can be disposed within the plurality of fin arrangements formed on the cooling plate.

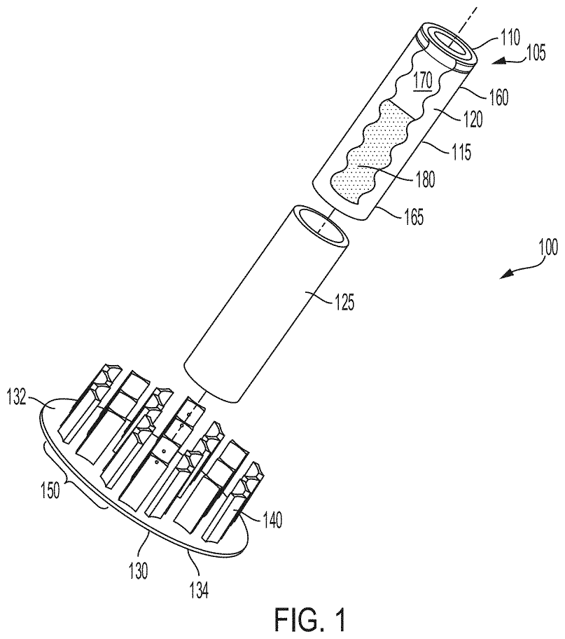

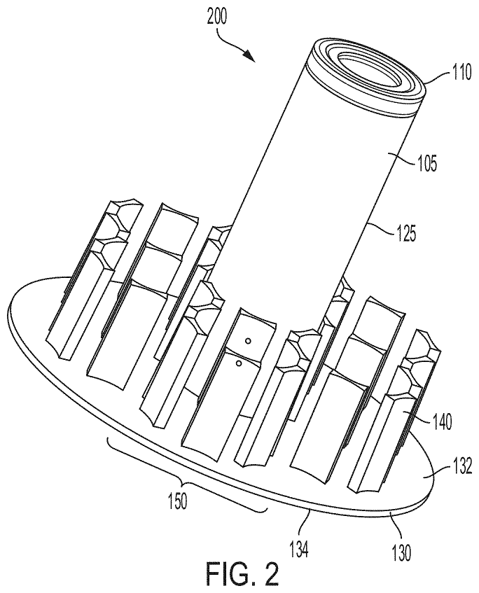

Systems and methods described herein relate to a heat transfer system for at least one battery cell of at least one battery pack to power an electric vehicle. FIGS. 1-2, among others, depict different views of a battery cell 105 for a battery pack in an electric vehicle. The battery cell 105 can include at least one lid 110 and at least one housing 115 having an outer surface 120. At least one sleeve 125 can couple with the outer surface 120 of the housing 115. As depicted in FIGS. 1-2, the battery cell 105 can couple with at least one cooling plate 130 having at least one fin 140 to facilitate or aid in heat transfer between the battery cell 105 and the cooling plate 130 having the plurality of fins 140. For example, FIG. 1 depicts an exploded view 100 of the battery cell 105 separated from the sleeve 125, the cooling plate 130 and the plurality of fins 140. FIG. 2 depicts a coupled view 200 of the battery cell 105 coupled with the sleeve 125, the cooling plate 130 and the plurality of fins 140. The cooling plate 130 and fins 140 can provide temperature regulation for the battery cell 105 during charging and other forms of operation of the battery cell 105 when the battery cell is disposed within a battery pack to power an electric vehicle.

The battery cell 105 can provide energy or store energy for an electric vehicle. For example, the battery cell 105 can be included in a battery pack used to power an electric vehicle. The battery cell 105 can include at least one housing 115. The housing 115 can have a first end 160 and a second end 165. The battery cell 105 can be a lithium-air battery cell, a lithium ion battery cell, a nickel-zinc battery cell, a zinc-bromine battery cell, a zinc-cerium battery cell, a sodium-sulfur battery cell, a molten salt battery cell, a nickel-cadmium battery cell, or a nickel-metal hydride battery cell, among others. The housing 115 can be included or contained in a battery pack (e.g., a battery array or battery module) installed a chassis of an electric vehicle. The housing 115 can have the shape of a cylindrical casing or cylindrical cell with a circular, ovular, or elliptical base, as depicted in the example of the battery cell of FIGS. 1-2, among others. A height of the housing 115 can be greater than a width of the housing 115. For example, the housing 115 can have a length (or height) in a range from 65 mm to 75 mm and a width (or diameter for circular examples) in a range from 15 mm to 27 mm. In some examples the width or diameter of the housing 115 can be greater than the length (e.g., height) of the housing 115. The housing 115 can be formed from a prismatic casing with a polygonal base, such as a triangle, square, a rectangular, a pentagon, or a hexagon, for example. A height of such a prismatic cell housing 115 can be less than a length or a width of the base of the housing 115. The battery cell 105 can be a cylindrical cell 21 mm in diameter and 70 mm in height. Other shapes and sizes are possible, such as a rectangular cells or rectangular cells with rounded edges, of cells between 15 mm to 27 mm in diameter or width, and 65 mm to 75 mm in length or height.

The housing 115 of the battery cell 105 can include at least one electrically or thermally conductive material, or combinations thereof. The electrically conductive material can also be a thermally conductive material. The electrically conductive material for the housing 115 of the battery cell 105 can include a metallic material, such as aluminum, an aluminum alloy with copper, silicon, tin, magnesium, manganese or zinc (e.g., of the aluminum 4000 or 5000 series), iron, an iron-carbon alloy (e.g., steel), silver, nickel, copper, and a copper alloy, among others. The electrically conductive material and thermally conductive material for the housing 115 of the battery cell 105 can include a conductive polymer. To evacuate heat from inside the battery cell 105, the housing 115 can be thermally coupled to a thermoelectric heat pump (e.g., a cooling plate) via an electrically insulating layer. The housing 115 can include an electrically insulating material. The electrically insulating material can be a thermally conductive material. The electrically insulating and thermally conductive material for the housing 115 of the battery cell 105 can include a ceramic material (e.g., silicon nitride, silicon carbide, titanium carbide, zirconium dioxide, beryllium oxide, and among others) and a thermoplastic material (e.g., polyethylene, polypropylene, polystyrene, or polyvinyl chloride), among others. To evacuate heat from inside the battery cell 105, the housing 115 can be thermally coupled to a thermoelectric heat pump (e.g., a cooling plate). The housing 115 can be directly thermally coupled to the thermoelectric heat pump without an addition of an intermediary electrically insulating layer.

The housing 115 of the battery cell 105 can include the first end 160 (e.g., top portion) and the second end 165 (e.g., bottom portion). The housing 115 can define an inner region 170 between the first end 160 and the second end 165. For example, the inner region 170 can include an interior of the housing 115 or an inner area formed by the housing 115. The first end 160, inner region 170, and the second end 165 can be defined along one axis of the housing 115. For example, the inner region 170 can have a width (or diameter for circular examples) of 2 mm to 6 mm and a length (or height) of 50 mm to 70 mm. The width or length of the inner region 170 can vary within or outside these ranges. The first end 160, inner region 170, and second end 165 can be defined along a vertical (or longitudinal) axis of cylindrical casing forming the housing 115. The first end 160 at one end of the housing 115 (e.g., a top portion as depicted in FIG. 1). The second end 165 can be at an opposite end of the housing 115 (e.g., a bottom portion as depicted in FIG. 1). The end of the second end 165 can encapsulate or cover the corresponding end of the housing 115.

The diameter (or width) of the first end 160 can be in a range from 15 mm to 27 mm. The diameter (or width) of the second end 165 can be in a range from 15 mm to 27 mm. The diameter (or width) can correspond to a shortest dimension along an inner surface of the housing 115 within the first end 160 or second end 165. The width can correspond to a width of a rectangular or polygonal lateral area of the first end 160 or second end 165. The diameter (or width) can correspond to a diameter of a circular or elliptical lateral area of the first end 160 or second 115. The width of the first end 160 (not including the indentation) can be less than the width of the second end 165 of the housing 115. The lateral area of the first end 160 (not including the indentation) can be less than the lateral area of the second end 165 of the housing 115.

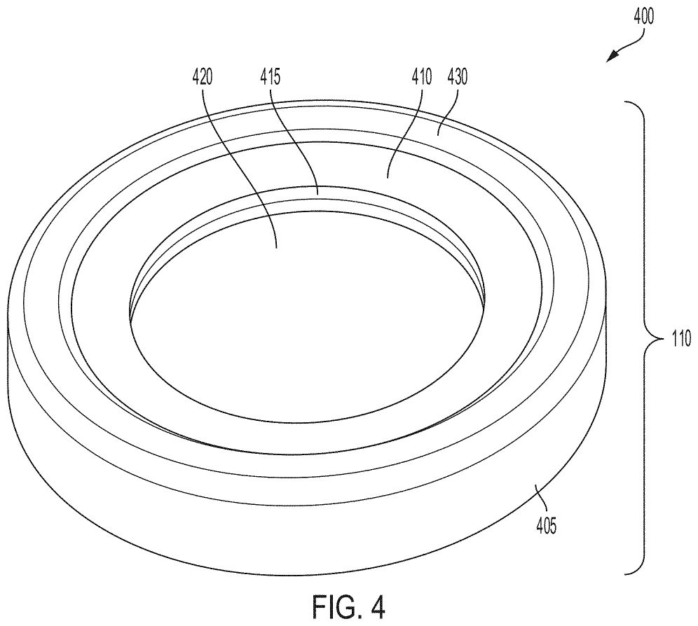

At least one electrolyte 180 can be disposed in the inner region 170 of the housing 115. The battery cell 105 can include multiple electrolytes 180 disposed in the inner region 170 of the housing. The electrolyte 180 can include a first polarity electronic charge region or terminus and a second polarity electronic charge region or terminus. For example, the electrolyte 180 can include a positive electronic charge region or terminus and a negative electronic charge region or terminus. A first polarity tab (e.g., negative tab) can couple a first polarity region of the electrolyte with a first polarity layer or first polarity region (e.g., first polarity region 410 of FIG. 4) of a lid 110 to form a first polarity surface area (e.g., negative surface area) on the lid 110 for first polarity wire bonding. At least one second polarity tab (e.g., positive tab) can couple a second polarity region of the electrolyte 180 (e.g., positive region of electrolyte 180) with a second polarity layer or second polarity region (e.g., second polarity region 420 of FIG. 4) of the lid 110. The electrolyte 180 can include any electrically conductive solution, dissociating into ions (e.g., cations and anions). For a lithium-ion battery cell, for example, the electrolyte 180 can include a liquid electrolyte, such as lithium bisoxalatoborate (LiBC4O8 or LiBOB salt), lithium perchlorate (LiClO4), lithium hexaflourophosphate (LiPF6), and lithium trifluoromethanesulfonate (LiCF3SO3). The electrolyte 180 can include a polymer electrolyte, such as polyethylene oxide (PEO), polyacrylonitrile (PAN), poly (methyl methacrylate) (PMMA) (also referred to as acrylic glass), or polyvinylidene fluoride (PVdF). The electrolyte 180 can include a solid-state electrolyte, such as lithium sulfide (Li2S), magnesium, sodium, and ceramic materials (e.g., beta-alumna). A single electrolyte 180 can be disposed within inner region 170 of the housing 115 or multiple electrolytes 180 (e.g., two electrolytes, more than two electrolytes) can be disposed within inner region 170 of the housing 115. For example, two electrolytes 180 can be disposed within inner region 170 of the housing 115. The number of electrolytes 180 can vary and can be selected based at least in part on a particular application of the battery cell 105.

The sleeve 125 can couple with the outer surface 120 of the housing 115 of the battery cell 105 to aid in the passive cooling of the battery cell 105. For example, the sleeve 125 can be disposed around the outer surface 120 of the housing 115 in a 360 degree direction. Thus, the sleeve 125 can surround or engulf the outer surface 120 of the housing 115 of the battery cell 105. The sleeve 125 can partially surround or partially engulf the outer surface 120 of the housing 115 of the battery cell 105. For example, the sleeve 125 can be wrapped around, engulf or be disposed about the outer surface of the housing 115 and not cover or contact a top end or bottom end of the housing 115. The sleeve 125 can be disposed about the housing 115 such that the sleeve 125 does not contact or cover a bottom surface or second end 165 of the housing 115. The sleeve 125 can be disposed about the housing 115 such that the sleeve 125 does not contact or cover the lid 110 or the first end 160 of the housing 115.

The sleeve 125 can be formed from electrically non-conductive material to insulate the battery cell 105 from one or more fins 140 disposed about the respective battery cell 105 in a battery pack. The sleeve 125 can be formed from thermally conductive material to facilitate or aid in heat transfer between the battery cell 105 and the one or more fins 140 or the cooling plate 130. For example, the sleeve 125 can include and be formed from electrically insulating and thermally conductive material. The sleeve 125 can include a thermally conductive plastic material, a plastic material, a ceramic material (e.g., silicon nitride, silicon carbide, titanium carbide, zirconium dioxide, beryllium oxide), a thermoplastic material (e.g., polyethylene, polypropylene, polystyrene, or polyvinyl chloride), a polymer material, insulation material, glass material, ceramic material or epoxy material. The sleeve 125 can formed having dimensions corresponding to the housing 115 of the battery cell 105. The dimensions of the sleeve 125 (e.g., length, width) can be formed to warp around in a 360 direction the circumference of the housing 115 of the battery cell 105. For example, the sleeve 125 can have dimensions corresponding to a circumference of the housing 115 of the battery cell 105. The sleeve 125 can have a length (or height) in a range from 50 mm to 70 mm. The length (or height) of the sleeve 125 can vary within or outside this range. The sleeve 125 when wrapped around the outer surface 120 of the housing 115 can have a diameter in a range from 15 mm to 27 mm. The diameter of sleeve 125 when wrapped around the outer surface 120 of the housing 115 can vary within or outside this range.

The battery cell 105 can couple with the cooling plate 130 having a plurality of fins 140. The cooling plate can have a first surface 132 (e.g., top surface) and a second surface 134 (e.g., bottom surface). The cooling plate 130 can include thermally conductive material to provide passive cooling or active cooling to the battery cell 105. For example, the cooling plate 130 can include aluminum material or an aluminum heat sink. The cooling plate 130 can include one or more different layers or one or more different materials. The different layers of the cooling plate 130 can be formed into a single layer during manufacture, such as by friction stir weld construction. The cooling plate 130 can provide passive cooling to the battery cell 105 through the material (e.g., aluminum) of the cooling plate 130. For example, an aluminum surface of the cooling plate 130 in contact with the second end 165 of the battery cell 105 of the sleeve 125 can provide passive cooling to the battery cell 105 for temperature regulation during operation of the battery cell 105. The geometry of the cooling plate 130 can be selected and formed to enhance heat transfer between the battery cell 105 and the material of the cooling plate 130 (e.g., aluminum). The geometry of the cooling plate 130 can be selected and formed to enhance heat transfer between the battery cell 105 and the material of the cooling plate 130 (e.g., aluminum) and the fluid flowing through the cooling passages. The cooling plate 130 can include one or more cooling passages formed within the cooling plate 130 to provide active cooling to the battery cell 105. For example, coolant fluid can flow through or otherwise be provided within the cooling passages formed within the cooling plate 130 to provide active cooling to the battery cell 105. The cooling plate 130 can be formed having a circular shape, square shape, an elliptical shape, a triangular shape, a rectangular shape, a hexagonal shape, or an octagonal shape. The shape of the cooling plate 130 can be selected based at least in part on the dimensions or shape of a battery pack. The cooling plate 130 can form a base or bottom surface of a battery pack.

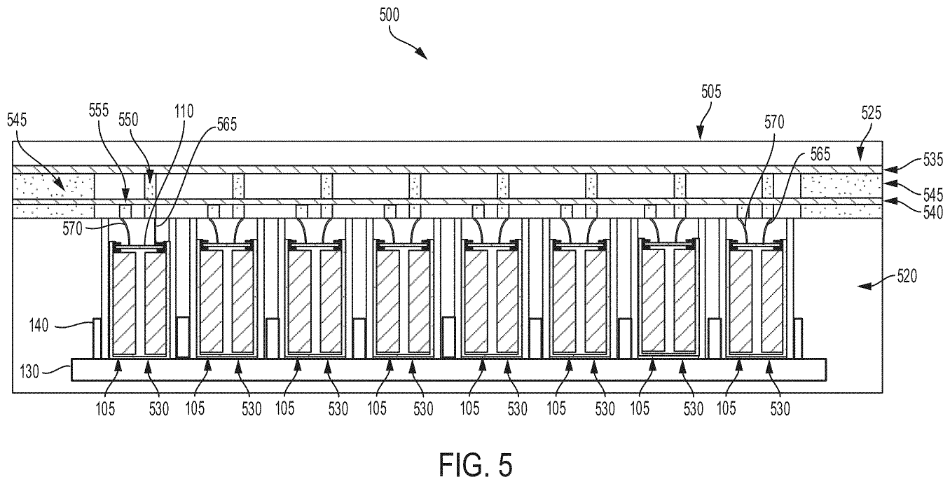

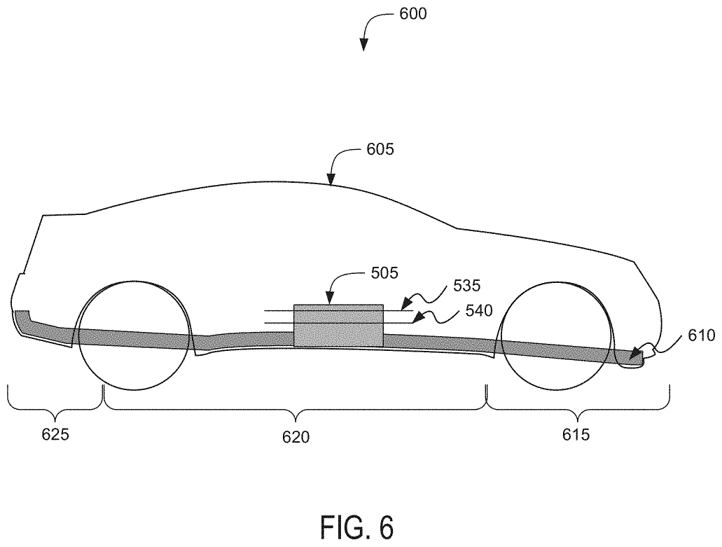

The cooling plate 130 and fins 140 can improve the ability to charge one or more battery cells 105 coupled with the first surface. The cooing plate 120 and fins 140 combination can improve fast charging capability of the battery cells 105. For example, cooling the battery cells 105 can improve the lifetime of the battery cells 105 in that more electrolyte degrades and more side reactions can be allowed to happen at higher temperatures leading to capacity fade. The more efficient thermal interface cooing plate 120 and fins 140 (e.g., thermal interface of aluminum) can aid in warming the battery cells 105 slightly to help them charge quickly whilst operating at very low temperatures. The length and width of the cooling plate 120 can vary. The length and width of the cooling plate 120 can correspond to different components the cooling plate 120 is to couple with or be disposed within. For example, the length of the cooling plate 120 can be the same as a length of a battery pack (e.g., battery pack 505). The length of the cooling plate 120 can be the selected such that the cooling plate 120 can be disposed within a battery pack (e.g., battery pack 505 of FIG. 5) of an electric vehicle (e.g., electric vehicle 605 of FIG. 6). The width of the cooling plate 120 can be the same as a width of a battery pack (e.g., battery pack 505). The width of the cooling plate 120 can be the selected such that the cooling plate 120 can be disposed within a battery pack (e.g., battery pack 505 of FIG. 5) of an electric vehicle (e.g., electric vehicle 605 of FIG. 6).

The plurality of fins 140 can extend from the first surface 132 of the cooling plate 130. The fins 140 can extend from a variety of different angles from the first surface 132 of the cooling plate 130 to fixture or position one or more battery cells 105 with the cooling plate 130 and provide heat transfer (e.g., passive cooling) to the one or more battery cells 105. For example, the fins 140 can extend perpendicular with respect to the first surface 132 of the cooling plate 130. The fins 140 can extend at an angle in a range from 30 degrees to 90 degrees with respect to the first surface 132 of the cooling plate 130. The angle the fins extend with respect to the first surface 132 of the cooling plate 130 can correspond to or be selected based at least in part on the arrangement of the battery cells 105 coupled with the first surface 132 of the cooling plate 130.

The fins 140 can include thermally conductive material to provide passive cooling to the battery cell 105. For example, the fins 140 can include aluminum material. The fins 140 can provide passive cooling to the battery cell 105 through the material (e.g., aluminum) of the cooling plate 130. For example, an aluminum surface of the fins 140 in contact with the sleeve 125 disposed around the outer surface of the housing 115 of the battery cell 105 can provide passive cooling to the battery cell 105 for temperature regulation during operation of the battery cell 105. The geometry or shape of the fins 140 can be selected and formed to enhance heat transfer between the battery cell 105 and the material of the fins 140 (e.g., aluminum). The geometry or shape of the fins 140 can be selected to increase or provide a greater amount of contact between a surface of each of the fins 140 and the sleeve 125 disposed around the outer surface of the housing 115 of the battery cell 105. For example, the geometry or shape of the fins 140 can be selected to match or correspond to the shape of the housing 115 of the battery cell 105. For example, the fins 140 can be formed having a curved shape. The curvature of the fins 140 can match or correspond to the shape (e.g., curved shape) of the housing 115 of the battery cell 105 such that the fins 140 can be flush with the sleeve 125 disposed around the outer surface of the housing 115 when the battery cells 105 are coupled with the cooling plate 130 and fins 140. Fins 140 can be formed having a straight or flat shape. The fins 140 can be formed having a circular shape, square shape, an elliptical shape, a triangular shape, a rectangular shape, a hexagonal shape, or an octagonal shape.

The fins 140 can be formed having a width or thickness in a range from 0.5 mm to 3 mm (e.g., 1 mm). The width or thickness of the fins 140 can vary within or outside this range. The fins 140 can have a height (e.g., length, vertical length) in a range from 10 mm to 70 mm. The height (e.g., length, vertical length) can vary within or outside this range. The height of the fins 140 can be selected to be less than a height of the housing 115 of the battery cells 105. Each of the plurality of fins 140 can be formed having the same height. The plurality of fins can be formed having different heights. For example, one or more of the plurality of fins 140 can have one or more different heights from each other. The fins 140 can be formed from or otherwise include the same material as the cooling plate 130. The fins 140 can couple with the first surface 132 of the cooling plate 130. The fins 140 can be integrally formed with the cooling plate 130 and thus, be extensions of the cooling plate 130.

The plurality of fins 140 can be organized or grouped into one or more fin arrangements 150. For example, each fin arrangement 150 can include two or more fins 140. Each of the fin arrangements 150 can be positioned to accept, receive or couple with at least one battery cell 105. The plurality of fins 140 of a fin arrangement 150 can be arranged in a 360 degree direction around a circumference of the battery cell 105. The plurality of fins 140 of a fin arrangement 150 can include multiple fins 140 that completely or partially surround a battery cell 105 when the respective battery cell 105 is disposed within or coupled with the fin arrangements. For example, a plurality of battery cells 105 can couple with the first surface 132 of the cooling plate with at least one battery cell 105 coupled with at least one fin arrangement 150 of the plurality of fin arrangements 150. The plurality of fin arrangements 150 can be organized in a variety of different patterns across the first surface 132 of the cooling plate 140. For example, the plurality of fin arrangements 150 can be organized in a hexagonal pattern, a circular pattern, a square pattern, an elliptical pattern, a triangular pattern, a rectangular pattern, a symmetrical pattern, an asymmetrical pattern, or an octagonal pattern. The plurality of fin arrangements 150 can be organized in a honey comb pattern. The plurality of fin arrangements 150 can be organized having a lattice pattern or form a lattice matrix. The plurality of fin arrangements 150 can be organized in a uniform pattern. For example, each of the plurality of fin arrangements 150 can be evenly spaced across the first surface 132 of the cooling plate 130.

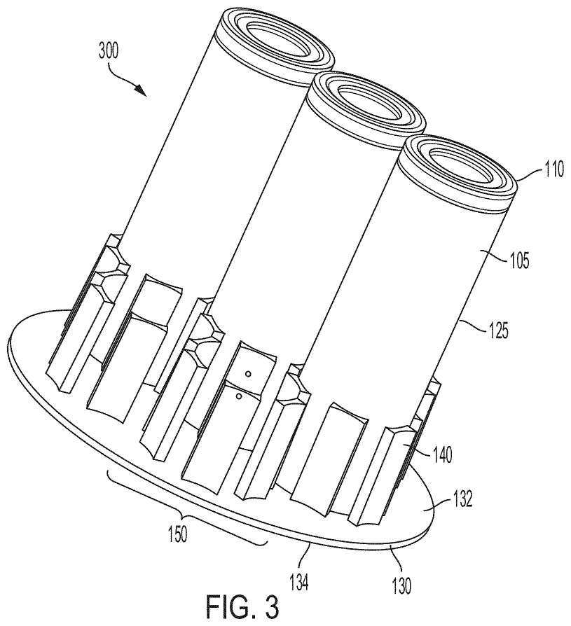

FIG. 3, among others, depicts a view 300 of multiple battery cells 105 coupled with different fin arrangements 150. For example, the plurality of fins 140 can be organized or grouped into one or more fin arrangements 150. For example, each fin arrangement 150 can include two or more fins 140. For example, each of the plurality of fins 140 can be part of or form a single fin arrangement 150, two fin arrangements 150 or more than two fin arrangements 150. For example, the plurality of fin arrangements 150 can be organized such that one or more fins 140 of a first fin arrangement 150 are part of or form a second fin arrangement 150 disposed next to or adjacent to the first fin arrangement 150. A first fin arrangement 150 can include a first fin 140, a second fin 140, a third fin 140, and a fourth fin 140. The first fin arrangement 150 can be disposed next to, adjacent to, or near a second fin arrangement 150, a third fin arrangement 150, and a fourth fin arrangement. The first fin 140 can be part of or form the first fin arrangement 150 and the second fin arrangement 150. For example, the first fin 140 can include a first surface facing or that forms part of the first fin arrangement 150 and a second surface facing or that forms part of the second fin arrangement 150. The second fin 140 can be part of or form the first fin arrangement 150 and the third fin arrangement 150. For example, the second fin 140 can include a first surface facing or that forms part of the first fin arrangement 150 and a second surface facing or that forms part of the third fin arrangement 150. The third fin 140 can be part of or form the first fin arrangement 150 and the fourth fin arrangement 150. For example, the third fin 140 can include a first surface facing or that forms part of the first fin arrangement 150 and a second surface facing or that forms part of the fourth fin arrangement 150. The fourth fin 140 can be disposed along an edge of the cooling plate 130 and can be part of the first fin arrangement 150. For example, the fourth fin 140 can include a first surface facing or that forms part of the first fin arrangement 150 and a second surface facing outwards or away from the plurality of fin arrangements 150 such that the second surface of the fourth fin 140 is not part of or does not form part of a fin arrangement 150.

Thus, each of the plurality of fins 140 can contact or couple with a sleeve 125 of a single battery cell 105 or sleeves 125 of two battery cells 105. For example, a first fin 140 of the plurality of fins 140 can include a first surface that contacts or couples with a first sleeve 125 of a first battery cell 105 and a second surface that contacts or couples with a second sleeve 125 of a second battery cell 105 that is different from the first battery cell 105. A second fin 140 of the plurality of fins 140 can include a first surface that contacts or couples with the first sleeve 125 of the first battery cell 105 and a second surface that contacts or couples with a third sleeve 125 of a third battery cell 105 that is different from the second battery cell 105.

Each of the fins 140 a fin arrangement 150 can be spaced from each other or a neighboring fin 140 by a predetermined distance. For example, the distance between each fin 140 in a fin arrangement 150 can range from 0.1 mm to 1 mm. The fin arrangements 150 formed along the first surface 132 can be organized to decrease the spacing between each of the respective battery cells 105. For example, a spacing between the battery cells 105 coupled with the cooling plate 130 can be reduced using the cooling plate 130 and plurality of fin arrangements 150. For example, spacing between a first battery cell 105 and a second battery cell 105 of a plurality of battery cells 105 coupled with the cooling plate 130 can range from 0.7 mm to 1 mm. The spacing between a first battery cell 105 and a second battery cell 105 of a plurality of battery cells 105 coupled with the cooling plate 130 can range from 0.7 mm to 0.9 mm. The spacing between a first battery cell 105 and a second battery cell 105 of a plurality of battery cells 105 coupled with the cooling plate 130 can range from 0.7 mm to 0.8 mm. The battery cell spacing can correspond to a distance from at least one battery cell to a neighboring, adjacent or proximate battery cell 105 of a plurality of battery cells disposed along the first surface 132 of the cooling plate 130 and disposed within a battery pack to power an electric vehicle. Stated differently, the battery cell spacing can correspond to a distance from at least one battery cell to the next closest, a neighboring, or nearest battery cell 105 of a plurality of battery cells disposed along the first surface 132 of the cooling plate 130 and disposed within a battery pack to power an electric vehicle. A fin arrangement 150 may be formed having a single fin 140 that extends around at least one battery cell 105 in a 360 degree direction. The fin arrangement 150 having a single fin 140 can formed to surround or be disposed about the sleeve 125 around the battery cell 105. For example, the fin 140 can be formed having a ring shape, donut shape or cup shape such that at least one battery cell 105 can be disposed within a middle portion or orifice of the respective fin arrangement 150 having a single fin 140.

Thus, the arrangement of the fins 130 along the first surface 132 of the cooling plate 130 can provide reduced or decreased inter-cellular spacing between the battery cells 105 of a battery pack and provide a higher energy density for the battery pack. For example, the battery cells 105 can couple with the fin arrangements 150 using less or no adhesive material, as used in traditional battery pack designs. Further, the fin arrangements 150 can position and keep the respective battery cells 105 in place to provide fixturing of the battery cells with reduced amounts of adhesive material. Thus, the spacing between each of the battery cells 105 in the battery pack can be reduced by coupling the battery cells 105 with the fin arrangements 150 along the first surface 132 of the cooling plate 130 and more battery cells 105 can be disposed within a battery pack for a higher energy density of the respective battery pack. Thus, the number of batter cells 105 within a battery pack can be increased using the cooling plate 130 and plurality of fin arrangements 150 to fixture and hold the battery cells 105 within the battery pack. The number of batter cells 105 disposed within a battery pack can vary and be selected based at least in part on the power needs of the respective battery pack. The reduced spacing between the battery cells 105 can provide an increased mechanical resistance of the battery pack. For example, the spacing and the additional aluminum material (aluminum mass) provided by the cooling plate 130 and fins 140 can provide increased resistance against compressive loading, improving a crashworthiness of the respective battery pack.

FIG. 4, among others, depicts a top view 400 of the lid 110 of the battery cell 105. For example, at least one lid 110 can be disposed proximate to the first end 160 of the housing 115. The lid 110 can be disposed onto the first lateral end 110 of the housing 115. The lid 110 can be crimped onto, clipped onto, or welded with the first end 160 to couple the lid 110 with the first end 160 of the housing 115. The coupling (e.g., crimped coupling, welded coupling) between the lid 110 and the first end 160 of the housing 115 can form a hermetic seal, a fluid resistant seal, or a hermetic seal and a fluid resistant seal between the lid 110 and the housing 115, for example, so that the fluid or material within the inner region 170 does not leak from its location within the housing 115. The lid 110 can have a diameter in a range from 12 mm to 30 mm. The diameter of the lid 110 can vary within or outside this range. The lid 110 can have a width (e.g. vertical width, height) in a range from 0.5 mm to 10 mm. The height of the lid 110 can vary within or outside this range.

The lid 110 can include an outer gasket 405, a first polarity region 410, an isolation region 415 and a second polarity region 420. The lid 110 can include the plurality of layers to provide a dual polarity lid having both at least one positive surface (e.g., second polarity region 420) and at least one negative surface (e.g., first polarity region 410) for coupling with positive and negative busbars of a battery pack of an electric vehicle. The lid 110 can include at least one outer gasket 405. The outer gasket 405 can couple with a first end 160 of the housing 115 of the battery cell 105 to seal the battery cell 105. For example, the seal formed between the outer gasket 405 and the first end 160 of the housing 115 can be a hermetic seal or fluid resistant seal, for example, so that the electrolyte 180 does not leak from its location within the housing 115. The coupling (e.g., crimped coupling, welded coupling) between the outer gasket 405 and the first end 160 of the housing 115 can form a hermetic seal, a fluid resistant seal, or a hermetic seal and a fluid resistant seal between the lid 110 and the housing 115. The outer gasket 405 can include non-conductive material, such as but not limited to, a polymer material, insulation material, plastic material, glass material, ceramic material or epoxy material. For example, the outer gasket 405 can electrically isolate the housing 115 of the battery cell 105 from the first polarity region 410 of the lid 110.

The outer gasket 405 can be formed having a shape corresponding to the shape of the housing 115 of the battery cell 105. For example, the outer gasket 405 can have a circular shape, square shape, an elliptical shape, a triangular shape, a rectangular shape, a hexagonal shape, a polygonal shape, or an octagonal shape. A width of the outer gasket 405 can range from 5 mm to 20 mm. The width of the outer gasket 405 can vary within or outside this range. A thickness of the outer gasket 405 can range from 0.1 mm to 5 mm. The thickness of the outer gasket 405 can vary within or outside this range. A diameter of the outer gasket 405 can range from 12 mm to 30 mm. The diameter of the outer gasket 405 can vary within or outside this range.

The outer gasket 405 can couple with the first polarity region 410. For example, tan outer edge surface of the first polarity region 410 can couple with an inner edge surface of the outer gasket 405. An adhesive material or adhesive layer can couple the outer gasket 405 with the first polarity region 410. For example, adhesive material or adhesive layer can couple the inner edge surface of the outer gasket 405 with the outer edge surface of the first polarity region 410. The outer gasket 405 can be crimped on or portions of the outer gasket 405 can be bent over the first polarity region 410. For example, the outer gasket 405 can include a crimped edge 430. The crimped edge 430 can correspond to a top end or first end of the battery cell 105. The crimped edge 430 can be disposed over portions of a first surface (e.g., top surface) of the first polarity region 410. For example, the crimped edge 430 can correspond to a surface or portion of the outer gasket that has been crimped over, bent over or otherwise formed over portions of the first surface of the first polarity region 410. The crimped edge 430 can extend over a portion of the first surface of the first polarity region 410 in a distance in a range from 0.1 mm to 5 mm.

The lid 110 can include at least one first polarity region 410. The first polarity region 410 can form or correspond to a first polarity terminal of the battery cell 105. For example, the first polarity region 410 can form or correspond to a negative polarity region and form or correspond a negative terminal of the battery cell 105. The first polarity region 410 can form or correspond to a positive polarity region and form or correspond a positive terminal of the battery cell 105. The first surface (e.g., top surface) of the first polarity region 410 can form or correspond to a first polarity terminal of the battery cell 105. For example, a first polarity wirebond can include a first end coupled with the first surface (e.g., top surface) of the first polarity region 410 and a second end coupled with a first polarity busbar of a battery pack of an electric vehicle.

The first polarity region 410 can be formed having a shape corresponding to the shape of the housing 115 of the battery cell 105 and thus, the battery cell 105. The first polarity region 410 can be formed having a circular shape, square shape, an elliptical shape, a triangular shape, a rectangular shape, a hexagonal shape, or an octagonal shape. The first polarity region 410 can include electrically conductive material, such as but not limited to, a metallic material, aluminum, or an aluminum alloy with copper. A width of the first polarity region 410 can range from 0.5 mm to 10 mm. The width of the first polarity region 410 can vary within or outside this range. A thickness of the first polarity region 410 can range from 6 mm to 15 mm. The thickness of the first polarity region 410 can vary within or outside this range. A diameter of the first polarity region 410 can range from 12 mm to 25 mm. The diameter of the first polarity region 410 can vary within or outside this range.

The lid 110 can include at least one isolation region 415. The isolation region 415 can electrically isolate or electrically insulate the first polarity region 410 from the second polarity region 420. For example, the isolation region 415 can be disposed within or coupled with an inner edge surface of the first polarity region 410. The isolation region 415 can include an inner isolation surface that couples with an outer edge surface of the second polarity region 420. Thus, the isolation region 415 can be disposed between the first polarity region 410 and the second polarity region 420. An adhesive layer or adhesive material can couple the isolation region 415 with the first polarity region 410 or the second polarity region 420. For example, an adhesive layer or adhesive material can couple the outer isolation surface of the isolation region 415 with the inner edge surface of the first polarity region 410. An adhesive layer or adhesive material can couple the inner isolation surface of the isolation region 415 with the outer edge surface of the second polarity region 420.

The isolation region 415 can be formed having a shape corresponding to the shape of the housing 115 of the battery cell 105. For example, the isolation region 415 can be formed having a circular shape, square shape, an elliptical shape, a triangular shape, a rectangular shape, a hexagonal shape, or an octagonal shape. The isolation region 415 can include non-conductive material, such as but not limited to, a polymer material, insulation material, plastic material, glass material, ceramic material or epoxy material. For example, the isolation region 415 can include an electrically insulating polymer. A width of the isolation region 415 can range from 0.5 mm to 15 mm. The width of the isolation region 415 can vary within or outside this range. A thickness of the isolation region 415 can range from 4 mm to 15 mm. The thickness of the isolation region 415 can vary within or outside this range. A diameter of the isolation region 415 can range from 12 mm to 25 mm. The diameter of the isolation region 415 can vary within or outside this range.

The lid 110 can include at least one second polarity region 420. The second polarity region 420 can form or correspond to a second polarity terminal of the battery cell 105. For example, the second polarity region 420 can form or correspond to a positive polarity region and form or correspond a positive terminal of the battery cell 105. The second polarity region 420 can form or correspond to a negative polarity region and form or correspond a negative terminal of the battery cell 105. A first surface of the second polarity region 420 can correspond to a second polarity terminal of the battery cell 105. For example, a second polarity wirebond can include a first end coupled with the first surface of the second polarity region 420 and a second end coupled with a second polarity busbar of a battery pack of an electric vehicle. The second polarity region 420 can have a different polarity than the first polarity region 410. For example, the first polarity region 410 can correspond to a negative polarity region and the second polarity region 420 can correspond to a positive polarity region. The first polarity region 410 can correspond to a positive polarity region and the second polarity region 420 can correspond to a negative polarity region.

The second polarity region 420 can be disposed within or couple with the isolation region 415. The second polarity region 420 can be disposed within or couple with the isolation region 415 such that the outer edge of the second polarity region 420 couples with or is in contact with the inner isolation surface of the isolation region 415. An adhesive layer or adhesive material can couple the second polarity region 420 with the isolation region 415. The second polarity region 420 can be formed having a circular shape, square shape, an elliptical shape, a triangular shape, a rectangular shape, a hexagonal shape, or an octagonal shape. A width of the second polarity region 420 can range from 0.5 mm to 15 mm. The width of the second polarity region 420 can vary within or outside this range. A diameter of the second polarity region 420 can range from 12 mm to 25 mm. The diameter of the second polarity region 420 can vary within or outside this range.

Thus, the battery cells 105 as described herein can include both the positive terminal (e.g., second polarity region 420) and the negative terminal (e.g., positive polarity terminal 410) disposed at a same lateral end (e.g., the top end) of the battery cell 105. For example, the lid 110 can provide a first polarity terminal (e.g., negative terminal, positive polarity terminal 410) for the battery cell 105 at the first end 160 and a second polarity terminal (e.g., positive terminal), second polarity region 420) for the battery cell 105 at the first end 160. Having both terminals, for the positive and the negative terminals on one end of the battery cell 105 can eliminate wire bonding to one side of the battery pack and welding of a tab to another side of the battery cell 105 (e.g., the bottom end or the crimped region). For example, the housing 115 of the battery cell 105 can be formed from non-electrically conductive material and thus, non-polarized material. In this manner, a terminal or an electrode tab along the bottom of the battery cell 105 can be eliminated from the structure. Thus improving the pack assembly process by making it easier to bond the wire to each of the first polarity terminal (e.g., negative terminal) and the second polarity terminal (e.g., positive terminal) of the battery cell 105.

FIG. 5 depicts a cross-section view 500 of a battery pack 505 to hold at least one battery cell 105, for example as part of a heat transfer system or apparatus to transfer heat from the battery cell 105 that can be part of the battery pack 505 that powers an electric vehicle. For example, the battery pack 505 can include battery cells 105 having a lid 110 that includes a first polarity region 410 and a second polarity region 420. The battery cell 105 can include a sleeve 125 disposed on an outer surface 120 of the housing 115 of the battery cell 105. The battery cell 105 can couple with a plurality of fins 140 of a cooling plate 130 within the battery pack 505. The battery cell 105 can be disposed in a battery pack 505 having multiple battery cells 105 coupled with different fin arrangements 150 formed along a first surface 132 of a cooling plate 130 within the battery pack 505. The battery pack 505 can include a single battery cell 105 coupled with a single fin arrangement 150 formed along a first surface 132 of a cooling plate 130 within the battery pack 505. The battery cells 105 can have an operating voltage in a range from 2.5 V to 5 V (e.g., 2.5 V to 4.2 V). The operating voltage of the battery cell 105 can vary within or outside this range. The battery pack 505 can include a battery case 520 and a capping element 525. The battery case 520 can be separated from the capping element 525. The battery case 520 can include or define a plurality of holders 530. Each holder 530 can include a hollowing or a hollow portion defined by the battery case 520. Each holder 530 can house, contain, store, or hold a battery cell 105. The battery case 520 can include at least one electrically or thermally conductive material, or combinations thereof. The battery case 520 can include one or more thermoelectric heat pumps. Each thermoelectric heat pump can be thermally coupled directly or indirectly to a battery cell 105 housed in the holder 530. Each thermoelectric heat pump can regulate temperature or heat radiating from the battery cell 105 housed in the holder 530. The first bonding element 565 and the second bonding element 570 can extend from the battery cell 105 through the respective holder 530 of the battery case 520. For example, the first bonding element 365 or the second bonding element 570 can couple with the first polarity region 410 of the lid 110 or the second polarity region 420 of the lid 110.

Between the battery case 520 and the capping element 525, the battery pack 505 can include a first busbar 535, a second busbar 540, and an electrically insulating layer 545. The first busbar 535 and the second busbar 540 can each include an electrically conductive material to provide electrical power to other electrical components in the electric vehicle. The first busbar 535 (e.g., a first current collector) can be connected or otherwise electrically coupled to the first bonding element 565 extending from each battery cell 105 housed in the plurality of holders 530 via a bonding element 550. The bonding element 550 can include electrically conductive material, such as a metallic material, aluminum, or an aluminum alloy with copper. The bonding element 550 can extend from the first busbar 535 to the first bonding element 565 extending from each battery cell 105. The bonding element 550 can be bonded, welded, connected, attached, or otherwise electrically coupled to the first bonding element 565 extending from the battery cell 105. The first bonding element 565 can define the first polarity terminal for the battery cell 105. The first bonding element 565 can include a first end coupled with a surface of the lid 110 (e.g., first polarity region 410, second polarity region 420) and a second end coupled with a surface of the bonding element 550. The first busbar 535 can define the first polarity terminal for the battery pack 505. The second busbar 540 (e.g., a second current collector) can be connected or otherwise electrically coupled to the second bonding element 570 extending from each battery cell 105 housed in the plurality of holders 530 via a bonding element 555. The bonding element 555 can include electrically conductive material, such as a metallic material, aluminum, or an aluminum alloy with copper. The bonding element 555 can extends from the second busbar 540 to the second bonding element 570 extending from each battery cell 105. The bonding element 555 can be bonded, welded, connected, attached, or otherwise electrically coupled to the second bonding element 570 extending from the battery cell 105. The second bonding element 570 can define the second polarity terminal for the battery cell 105. The second bonding element 570 can include a first end coupled with a surface of the lid 110 (e.g., first polarity region 410, second polarity region 420) and a second end coupled with a surface of the bonding element 555. The second busbar 540 can define the second polarity terminal for the battery pack 505.

The first busbar 535 and the second busbar 540 can be separated from each other by the electrically insulating layer 545. The electrically insulating layer 545 can include any electrically insulating material or dielectric material, such as air, nitrogen, sulfur hexafluoride (SF6), porcelain, glass, and plastic (e.g., polysiloxane), among others to separate the first busbar 535 from the second busbar 540. The electrically insulating layer 545 can include spacing to pass or fit the first bonding element 565 connected to the first busbar 535 and the second bonding element 570 connected to the second busbar 540. The electrically insulating layer 545 can partially or fully span the volume defined by the battery case 520 and the capping element 525. A top plane of the electrically insulating layer 545 can be in contact or be flush with a bottom plane of the capping element 525. A bottom plane of the electrically insulating layer 545 can be in contact or be flush with a top plane of the battery case 520.

FIG. 6 depicts a cross-section view 600 of an electric vehicle 605 installed with a battery pack 505. The battery cell 105 and the battery pack 505 can be part of a system that transfers heat from the battery pack 505. The battery pack 505 can include at least one battery cell 105 having a lid 110 that includes a first polarity region 410 and a second polarity region 420. The battery cell 105 can include a sleeve 125 disposed on an outer surface 120 of the housing 115 of the battery cell 105. The battery cell 105 can couple with a plurality of fins 140 of a cooling plate 130 within the battery pack 505. The battery cells 105 described herein can be used to form battery packs 505 residing in electric vehicles 605 for an automotive configuration. For example, the battery cell 105 can be disposed in the battery pack 505 and the battery pack 505 can be disposed in the electric vehicle 605. An automotive configuration includes a configuration, arrangement or network of electrical, electronic, mechanical or electromechanical devices within a vehicle of any type. An automotive configuration can include battery cells for battery packs in vehicles such as electric vehicles (EVs). EV s can include electric automobiles, cars, motorcycles, scooters, passenger vehicles, passenger or commercial trucks, and other vehicles such as sea or air transport vehicles, planes, helicopters, submarines, boats, or drones. EVs can be fully autonomous, partially autonomous, or unmanned. Thus, the electric vehicle 605 can include an autonomous, semi-autonomous, or non-autonomous human operated vehicle. The electric vehicle 605 can include a hybrid vehicle that operates from on-board electric sources and from gasoline or other power sources. The electric vehicle 605 can include automobiles, cars, trucks, passenger vehicles, industrial vehicles, motorcycles, and other transport vehicles. The electric vehicle 605 can include a chassis 610 (e.g., a frame, internal frame, or support structure). The chassis 610 can support various components of the electric vehicle 605. The chassis 610 can span a front portion 615 (e.g., a hood or bonnet portion), a body portion 620, and a rear portion 625 (e.g., as a trunk portion) of the electric vehicle 605. The front portion 615 can include the portion of the electric vehicle 605 from the front bumper to the front wheel well of the electric vehicle 605. The body portion 620 can include the portion of the electric vehicle 605 from the front wheel well to the back wheel well of the electric vehicle 605. The rear portion 625 can include the portion of the electric vehicle 605 from the back wheel well to the back bumper of the electric vehicle 605.

The battery pack 605 that includes at least one battery cell 105 having a lid 110 that includes a first polarity region 410 and a second polarity region 420 can be installed or placed within the electric vehicle 605. The battery pack 605 can include at least one cooling plate 130 having a plurality of fin arrangements 150 to couple with one or more battery cells 105. The battery pack 505 can couple with a drive train unit of the electric vehicle 605. The drive train unit may include components of the electric vehicle 605 that generate or provide power to drive the wheels or move the electric vehicle 605. The drive train unit can be a component of an electric vehicle drive system. The electric vehicle drive system can transmit or provide power to different components of the electric vehicle 605. For example, the electric vehicle drive train system can transmit power from the battery pack 505 to an axle or wheels of the electric vehicle 605. The battery pack 505 can be installed on the chassis 610 of the electric vehicle 605 within the front portion 615, the body portion 620 (as depicted in FIG. 6), or the rear portion 625. A first busbar 535 (e.g., first polarity busbar) and a second busbar 540 (e.g., second polarity busbar) can be connected or otherwise be electrically coupled with other electrical components of the electric vehicle 605 to provide electrical power from the battery pack 505 to the other electrical components of the electric vehicle 605. For example, the first busbar 535 can couple with at least one surface of a battery cell 105 (e.g., first polarity region 410 of the id 135) of the battery pack 505 through a wirebond or bonding element (e.g., bonding element 550 of FIG. 5). The second busbar 540 can couple with at least one surface of a battery cell 105 (e.g., second polarity region 420 of the lid 110) of the battery pack 505 through a wirebond or bonding element (e.g., bonding element 555 of FIG. 5).

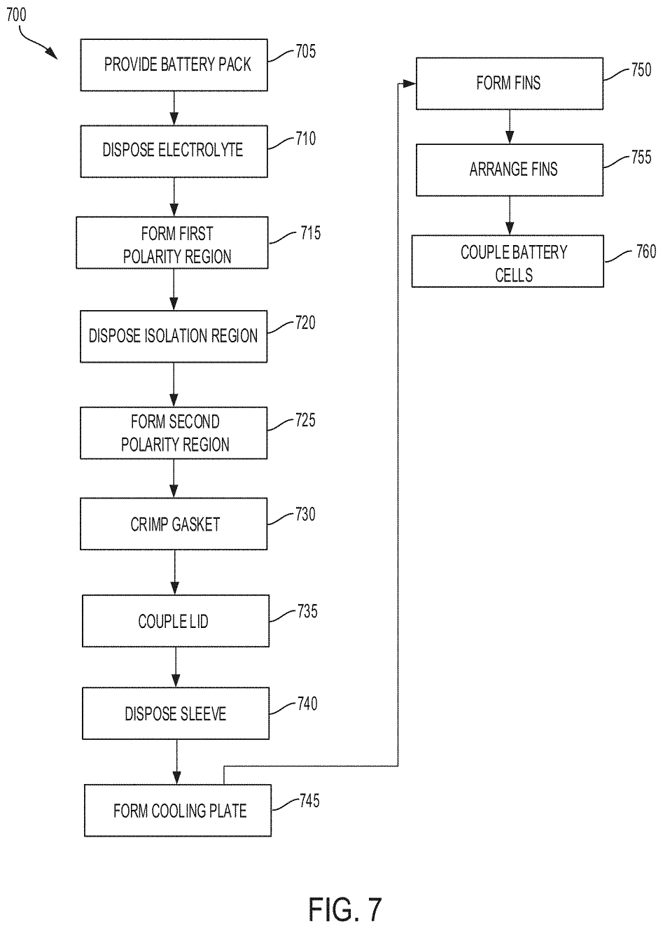

FIG. 7, among others, depicts a flow diagram of a method 700 of providing a battery cell 105 of a battery pack 505 to power an electric vehicle 605. The method 700 can include providing a battery pack 505 (ACT 705). For example, the method 700 can include providing a battery pack 505 having a battery cell 105. The battery cell 105 can include a housing 115 that includes a first end 160 and a second end 165. The housing 115 can be formed having or defining an inner region 170. The battery cell 105 can be a lithium ion battery cell, a nickel-cadmium battery cell, or a nickel-metal hydride battery cell. The battery cell 105 can be part of a battery pack 505 installed within a chassis 610 of an electric vehicle 605. For example, the battery cell 105 can be one of multiple battery cells 105 disposed within a battery pack 505 of the electric vehicle 605 to power the electric vehicle 605. The housing 115 can be formed from a cylindrical casing with a circular, ovular, elliptical, rectangular, or square base or from a prismatic casing with a polygonal base.

The method 700 can include disposing an electrolyte 180 (ACT 710). For example, method 700 can include disposing an electrolyte 180 in the inner region 170 defined by the housing 115. The electrolyte 180 can be disposed in the inner region 170 defined by the housing 115 of the battery cell 105. A single electrolyte 180 can be disposed within the inner region 170 or multiple electrolytes 180 (e.g., two or more) can be disposed within the inner region 170. The electrolytes 180 can be positioned within the inner region 170 such that they are spaced evenly from each other. For example, the electrolytes 180 can be positioned within the inner region 170 such that they are not in contact with each other. One or more insulation materials may be disposed between different electrolytes 180 within the same or common inner region 170. The electrolytes 180 can be positioned within the inner region 170 such that they are spaced a predetermined distance from an inner surface of the housing 115. For example, insulation materials may be disposed between different inner surfaces of the housing 115 and the electrolytes 180 within the inner region 170 to insulate the housing 115 from the electrolytes 180. Thus, a distance the electrolytes 180 are spaced from the inner surface of the housing 115 can correspond to a thickness of the insulation materials. An insulation material can electrically insulate portions or surfaces of a lid 110 from the electrolyte 180. The insulation material can be disposed over a top surface of the electrolyte 180 such that the insulation material is disposed between the electrolyte 180 and portions of the lid 110.

The method 700 can include forming a first polarity region 410 (ACT 715). For example, a first polarity region 410 can be formed from an electrically conductive material (e.g., aluminum) to form a first polarity region for the battery cell 105. The first polarity region 410 can form a first polarity terminal for the lid 110 and thus, the battery cell 105. For example, the first polarity region 410 can be formed from conductive material. The first polarity region 410 can couple with a first polarity portion of the electrolyte 180 disposed within the housing 115 of the battery cell 105. The first polarity region 410 can be formed having a shape corresponding to the housing 115 of the battery cell 105. For example, the first polarity region 410 can be formed having a circular shape, square shape, an elliptical shape, a triangular shape, a rectangular shape, a hexagonal shape, or an octagonal shape. An orifice can be formed through the first polarity region 410. The orifice can provide a hole or opening through the first polarity region 410. The first polarity region 410 having the orifice can form a ring shape, cup shape, donut shape or the similar. The shape of the first polarity region 410 can be selected to receive or dispose within other layers of a lid 110 of the battery cell 105.

The method 700 can include disposing an isolation region 415 (ACT 720). For example, an isolation region 415 can be disposed within the orifice of the first polarity region 410. For example, the isolation region 415 can be disposed within the orifice of the first polarity region 410 such that an outer isolation surface of the isolation region 415 couples with or is in contact with an inner edge surface of the first polarity region 410. Disposing an isolation region 415 can include providing an adhesive layer or adhesive material over the outer edge surface of the isolation region 415 or over the inner edge surface of the first polarity region 410. For example, an adhesive layer or adhesive material can couple the outer isolation surface of the isolation region 415 with the inner edge surface of the first polarity region 410. The outer isolation surface of the isolation region 415 may couple with the inner edge surface of the first polarity region 410 through a welded connection (e.g., spot weld). The isolation region 415 can be formed having a shape corresponding to the shape of the first polarity region 410. For example, the isolation region 415 can be formed having a circular shape, square shape, an elliptical shape, a triangular shape, a rectangular shape, a hexagonal shape, or an octagonal shape. An orifice can be formed through the isolation region 415. For example, the orifice can include an opening or hole formed through the isolation region 415. The inner isolation surface of the isolation region 415 can form a wall or border of the orifice. The isolation region 415 having the orifice can form a ring shape, cup shape, donut shape or the similar. The shape of the isolation region 415 can be selected to receive or dispose within other layers of a lid 110 of the battery cell 105. The isolation region 415 can be formed from non-conductive material to electrically isolate or insulate one or more layers (e.g., second polarity region 420) of the lid 110 from the first polarity region 410. For example, the isolation region 415 can be positioned between one or more layers (e.g., second polarity region 420) of the lid 110 and the first polarity region 410 to provide electrical isolation or insulation.

The method 700 can include forming a second polarity region 420 (ACT 725). For example, a second polarity region 420 can be formed or disposed within the orifice of the isolation region 415. The second polarity region 420 can form a second polarity terminal for the lid 110 and thus, the battery cell 105. For example, the second polarity region 420 can be formed from conductive material. The second polarity region 420 can couple with a second polarity portion of the electrolyte 180 disposed within the housing 115 of the battery cell 105. Forming the second polarity region 420 can include disposing the second polarity region 420 within the isolation region 415. For example, the second polarity region 420 can be disposed within or couple with the isolation region 41 such that an outer edge of the second polarity region 420 couples with or is in contact with the inner isolation surface of the isolation region 415. Forming the second polarity region 420 can include forming an outer portion, an inner portion, and a scored region on the second polarity region 420. For example, the scored region can be disposed between the outer portion and the inner portion of the second polarity region 420. For example, the scored region can separate the outer portion from the inner portion of the second polarity region 420. The scored region can be formed having a “C” shape. For example, the scored region can be formed such that it partially separates the outer portion from the inner portion second polarity region 420. The scored region can be formed to operate as a vent during a thermal event or over pressurization of the battery cell 105. For example, the second polarity region 420 can correspond to a vent plate for the lid 110 and battery cell 105. The scored region can be formed and shaped to break an electrical connection between the battery cell 105 and a busbar of a battery pack 505 in response to a thermal event or over pressurization of the battery cell 105. Forming the scored region can include forming a scored, thinned or otherwise structurally weakened region of the second polarity region 420. For example, the scored region can include a groove, divot or series of deformations formed into a first surface (e.g., top surface) or a second surface (e.g., bottom surface) of the second polarity region 420. The second polarity region 420 can be formed having a shape correspond to the shape of the isolation region 415 or the first polarity region 410. For example, the second polarity region 420 can be formed having a circular shape, square shape, an elliptical shape, a triangular shape, a rectangular shape, a hexagonal shape, or an octagonal shape.

The method 700 can include crimping an outer gasket 405 on an outer edge surface of the first polarity region 410 to form a lid 110 for the battery cell 105 (ACT 730). The lid 110 can include an outer gasket 405 that forms an outer border of the lid 110. The outer gasket 405 can be formed over or disposed over portions of the first polarity region 410 to electrically isolate or insulate the housing 115 of the battery cell 105 from the first polarity region 410 when the lid 110 is coupled with the housing 115. For example, coupling the outer gasket 405 can include crimping, bending or otherwise manipulating an edge surface or outer surface of the outer gasket 405 over at least one surface (e.g., side surface, top surface) of the first polarity region 410. Crimping the outer gasket 405 can include crimping or bending a top end or first end of the outer gasket 405 over the outer edge surface of the first polarity region 410. Crimping the outer gasket 405 can include crimping or bending a top end or first end of the outer gasket 405 over portions of a first surface of the first polarity region 410. Thus, crimping the outer gasket 405 can include forming a crimped edge 430 of the outer gasket 405. The crimped edge 430 can correspond to a surface or portion of the outer gasket that has been crimped over, bent over or otherwise formed over the outer edge surface 207 of the first polarity region 410 and portions of the first surface of the first polarity region 410.

An orifice can be formed through the outer gasket 405. The orifice can correspond to a hole or opening formed through the outer gasket 405. The first polarity region 410, coupled with the isolation region 415 and second polarity region 420, can be disposed within the orifice of the outer gasket 405. An adhesive material or adhesive layer can couple the outer gasket 405 with the first polarity region 410. For example, adhesive material or adhesive layer can couple the outer edge surface of the outer gasket 405 with the outer edge surface of the first polarity region 410.

The method 700 can include coupling the lid 110 with the first end 160 of the housing 115 to seal the battery cell 105 (ACT 735). Coupling the lid 110 can include crimping or welding the outer gasket 405 with the first end 160 of the housing 115. The outer gasket 405 can contact and couple with at least one surface of the first end 160 of the housing 115 to seal the battery cell 105. For example, the coupling between the outer gasket 405 and the first end 160 of the housing 115 can form a hermetic seal or fluid resistant seal, for example, so that the electrolyte 180 does not leak from its location within the housing 115. The coupling (e.g., crimped coupling, welded coupling) between the outer gasket 405 and the first end 160 of the housing 115 can form a hermetic seal, a fluid resistant seal, or a hermetic seal and a fluid resistant seal between the lid 110 and the housing 115. The outer gasket 405 can be positioned between the first end 160 of the housing 115 and the first polarity region 410 to electrically isolate the first end 160 of the housing 115 from the first polarity region 410. The outer gasket 405 can be formed from non-conductive material.

The method 700 can include disposing a sleeve 125 on an outer surface 120 of the housing 115 of the battery cell 105 (ACT 740). The sleeve 125 can couple with the outer surface 120 of the housing 115 of the battery cell 105 to aid in the passive cooling of the battery cell 105. For example, the sleeve 125 can be disposed around the outer surface 120 of the housing 115 in a 360 direction. Thus, the sleeve 125 can completely surround or engulf the outer surface 120 of the housing 115 of the battery cell 105. The sleeve 125 can partially surround or partially engulf the outer surface 120 of the housing 115 of the battery cell 105. For example, the sleeve 125 can be wrapped around, engulf or be disposed about the outer surface of the housing 115 and not cover or contact a top end or bottom end of the housing 115. The sleeve 125 can be disposed about the housing 115 such that the sleeve 125 does not contact or cover a bottom surface or second end 165 of the housing 115. The sleeve 125 can be disposed about the housing 115 such that the sleeve 125 does not contact or cover the lid 110 or the first end 160 of the housing 115.

The sleeve 125 can be formed from electrically non-conductive material to insulate the battery cell 105 from one or more fins 140 disposed about the respective battery cell 105 in a battery pack. The sleeve 125 can be formed from thermally conductive material to facilitate or aid in heat transfer between the battery cell 105 and the one or more fins 140 or the cooling plate 130. For example, the sleeve 125 can include and be formed from electrically insulating and thermally conductive material. The sleeve 125 can include a thermally conductive plastic material, a plastic material, a ceramic material (e.g., silicon nitride, silicon carbide, titanium carbide, zirconium dioxide, beryllium oxide), a thermoplastic material (e.g., polyethylene, polypropylene, polystyrene, or polyvinyl chloride), a polymer material, insulation material, glass material, ceramic material or epoxy material. The sleeve 125 can have dimensions corresponding to the housing 115 of the battery cell 105. The dimensions of the sleeve 125 (e.g., length, width) can be formed to warp around in a 360 direction the circumference of the housing 115 of the battery cell 105. For example, the sleeve 125 can have dimensions corresponding to a circumference of the housing 115 of the battery cell 105. The sleeve 125 can have a length (or height) in a range from 50 mm to 70 mm. The length (or height) of the sleeve 125 can vary within or outside this range. The sleeve 125 when wrapped around the outer surface 120 of the housing 115 can have a diameter in a range from 15 mm to 27 mm. The diameter of sleeve 125 when wrapped around the outer surface 120 of the housing 115 can vary within or outside this range.

The method 700 can include forming or otherwise providing a cooling plate 130 (ACT 745). For example, a cooling plate 130 can be formed to provide passive cooling or active cooling to one or more battery cells 105 disposed within a battery pack 505. The cooling plate 130 can be formed having a first surface 132 (e.g., top surface) and a second surface 134 (e.g., bottom surface). The cooling plate 130 can be formed from thermally conductive material to provide passive cooling or active cooling to the battery cell 105. For example, the cooling plate 130 can include aluminum material or an aluminum heat sink. The cooling plate 130 can be formed from one or more different layers or one or more different materials. The different layers of the cooling plate 130 can be formed into a single layer during manufacture, such as by friction stir weld construction. The cooling plate 130 can provide passive cooling to the battery cell 105 through the material (e.g., aluminum) of the cooling plate 130. For example, an aluminum surface of the cooling plate 130 in contact with the second end 165 of the battery cell 105 of the sleeve 125 can provide passive cooling to the battery cell 105 for temperature regulation during operation of the battery cell 105. The cooling plate 130 can be formed having a geometry selected to enhance heat transfer between the battery cell 105 and the material of the cooling plate 130 (e.g., aluminum). One or more cooling passages can be formed within the cooling plate 130. The cooling passages can be formed within the cooling plate 130 to provide active cooling to the battery cell 105. For example, coolant fluid can flow through or otherwise be provided within the cooling passages formed within the cooling plate 130 to provide active cooling to the battery cell 105. The cooling plate 130 can be formed having a circular shape, square shape, an elliptical shape, a triangular shape, a rectangular shape, a hexagonal shape, or an octagonal shape. The shape of the cooling plate 130 can be selected based at least in part on the dimensions or shape of a battery pack.

The method 700 can include forming fins 140 on the cooling plate 130 (ACT 750). For example, a plurality of fins 140 can be formed on the first surface 132 (e.g., top surface) of the cooling plate 130. The fins 140 can formed to extend from the first surface 132 of the cooling plate 130 at a variety of different angles to fixture or position one or more battery cells 105 with the cooling plate 130 and provide heat transfer (e.g., passive cooling) to the one or more battery cells 105. For example, the fins 140 can be formed such that the fins 140 extend perpendicular with respect to the first surface 132 of the cooling plate 130. The fins 140 can extend at an angle in a range from 30 degrees to 90 degrees with respect to the first surface 132 of the cooling plate 130. The fins 140 can be formed from thermally conductive material to provide passive cooling to the battery cell 105. For example, the fins 140 can include aluminum material. The fins 140 can provide passive cooling to the battery cell 105 through the material (e.g., aluminum) of the cooling plate 130. For example, an aluminum surface of the fins 140 in contact with the sleeve 125 disposed around the outer surface of the housing 115 of the battery cell 105 can provide passive cooling to the battery cell 105 for temperature regulation during operation of the battery cell 105.

The fins 140 can be formed having a geometry or shape that is selected to increase or provide a greater amount of contact between a surface of each of the fins 140 and the sleeve 125 disposed around the outer surface of the housing 115 of the battery cell 105. For example, the geometry or shape of the fins 140 can be selected to match or correspond to the shape of the housing 115 of the battery cell 105. The fins 140 can be formed having a curved shape. The curvature of the fins 140 can match or correspond to the shape (e.g., curved shape) of the housing 115 of the battery cell 105 such that the fins 140 can be flush with the sleeve 125 disposed around the outer surface of the housing 115 when the battery cells 105 are coupled with the cooling plate 130 and fins 140. Fins 140 can be formed having a straight or flat shape. The fins 140 can be formed having a circular shape, square shape, an elliptical shape, a triangular shape, a rectangular shape, a hexagonal shape, or an octagonal shape. The fins 140 can be formed having a width or thickness in a range from 0.5 mm to 3 mm (e.g., 1 mm). The width or thickness of the fins 140 can vary within or outside this range. The fins 140 can have a height (e.g., length, vertical length) in a range from 10 mm to 70 mm. The height (e.g., length, vertical length) can vary within or outside this range. The height of the fins 140 can be selected to be less than a height of the housing 115 of the battery cells 105. Each of the plurality of fins 140 can be formed having the same height. The plurality of fins can be formed having different heights. For example, one or more of the plurality of fins 140 can have one or more different heights from each other.

The method 700 can include organizing the fins 140 in a plurality of fin arrangements 150 (ACT 755). For example, the plurality of fins 140 can be organized in a plurality of fin arrangements 150 across the first surface 132 of the cooling plate 130. The plurality of fins 140 can be organized or grouped into one or more fin arrangements 150. For example, each fin arrangement 150 can include two or more fins 140. The plurality of fin arrangements 150 can be organized in a variety of different patterns across the first surface 132 of the cooling plate 140. For example, the plurality of fin arrangements 150 can be organized in a hexagonal pattern, a circular pattern, a square pattern, an elliptical pattern, a triangular pattern, a rectangular pattern, or an octagonal pattern. The plurality of fin arrangements 150 can be organized in a honey comb pattern. The plurality of fin arrangements 150 can be organized having a lattice pattern or form a lattice matrix. The plurality of fin arrangements 150 can be organized in a uniform pattern. For example, each of the plurality of fin arrangements 150 can be evenly spaced across the first surface 132 of the cooling plate 130.

The method 700 can include coupling one or more battery cells 105 with the cooling plate 130 (ACT 760). For example, a battery cell 105 can be disposed within and couple with at least one fin arrangement 150 formed along the first surface 132 of the cooling plate 130. Thus, a second end 165 of the battery cell 105 can couple with or contact the first surface 132 of the cooling plate 130. The plurality of fin arrangements 150 can be positioned to accept, receive or couple with at least one battery cell 105. For example, a plurality of battery cells 105 can couple with the first surface 132 of the cooling plate with at least one battery cell 105 coupled with at least one fin arrangement 150 of the plurality of fin arrangements 150.

Multiple battery cells 105 can be disposed within or coupled with different fin arrangements 150. For example, each of the plurality of fins 140 can contact or couple with a sleeve 125 of a single battery cell 105 or sleeves 125 of two battery cells 105. The fin arrangement 150 can provide a predetermined spacing for the battery cells 105 coupled with the cooling plate 130. For example, the fin arrangements 150 formed along the first surface 132 can be organized to decrease the spacing between each of the respective battery cells 105. Coupling the battery cells 105 with the cooling plate 130 can include providing a spacing between a first battery cell 105 and a second battery cell 105 of a plurality of battery cells 105 coupled with the cooling plate 130 in a range from 0.7 mm to 1 mm. Coupling the battery cells 105 with the cooling plate 130 can include providing a spacing between a first battery cell 105 and a second battery cell 105 in a range from 0.7 mm to 0.9 mm. Coupling the battery cells 105 with the cooling plate 130 can include providing a spacing between a first battery cell 105 and a second battery cell 105 in a range from 0.7 mm to 0.8 mm.

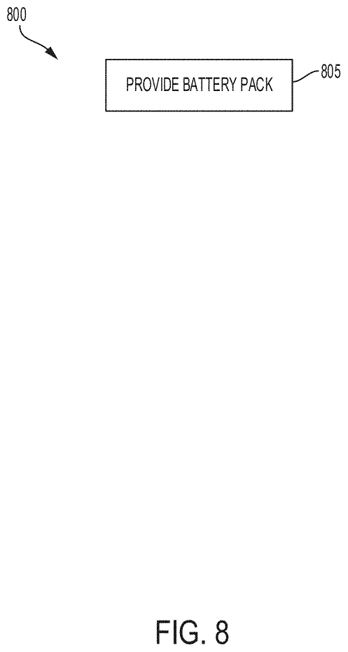

FIG. 8 depicts a method 800. The method 800 can include providing a battery pack 505 having at least one battery cell 105 for electric vehicles 605 (ACT 805). The battery pack 505 can include at least one battery cell 105. The battery cell 105 can include a housing 115 having a first end 160 and a second end 165. The housing 115 can define an inner region 170. An electrolyte 180 can be disposed in the inner region 170 defined by the housing 115. A lid 110 can couple with a first end 160 of the housing 115. A sleeve 125 can couple with an outer surface 120 of the housing 115 of the battery cell 105. A cooling plate 130 can couple with the second end 165 of the housing 115 of the battery cell 105. The cooling plate 130 can include a first surface 132 and a second surface 134. A plurality of fins 140 can extend from the first surface 132 of the cooling plate 130. The plurality of fins 140 can be disposed around the battery cell 105 and coupled with the sleeve 125 to facilitate heat transfer between the battery cell 105, the plurality of fins 140 and the cooling plate 130.

While acts or operations may be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Systems and methods described herein may be embodied in other specific forms without departing from the characteristics thereof. For example, descriptions of positive and negative electrical characteristics may be reversed. Further, all or some of the elements described in FIGS. 1-6 can comprise a system or apparatus to transfer heat (e.g., a thermal transfer system) between the described elements or components. Elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A heat transfer system for battery cells to power electric vehicles, comprising:
a battery cell of a battery pack to power an electric vehicle, the battery cell comprising:
a housing that defines an inner region, the housing having a first end and a second end;
an electrolyte disposed within the inner region; and
a lid coupled with the first end of the housing;
the lid comprising an outer gasket, a first polarity region, an isolation region, and a second polarity region, the outer gasket coupled with the first end of the housing and the first polarity region, the isolation region disposed within an inner edge surface of the first polarity region, and an outer edge of the second polarity region coupled with an inner isolation surface of an orifice of the isolation region; and
a sleeve coupled with an outer surface of the housing of the battery cell;
a cooling plate coupled with the second end of the housing of the battery cell, the cooling plate having a first surface and a second surface;
a plurality of fins extending from the first surface of the cooling plate; and
the plurality of fins disposed around the battery cell and coupled with the sleeve to transfer heat between the battery cell, the plurality of fins and the cooling plate.

2. The system of claim 1, comprising:
a plurality of fin arrangements extending from the first surface of the cooling plate; and
each of the plurality of fin arrangements having at least two fins of the plurality of fins.

3. The system of claim 1, comprising:
a plurality of battery cells;
a plurality of fin arrangements extending from the first surface of the cooling plate; and
each of the plurality of battery cells coupled with at least one fin arrangement of the plurality of fin arrangements.

4. The system of claim 1, comprising:
the plurality of fins arranged in a hexagonal pattern along the first surface of the cooling plate.

5. The system of claim 1, comprising:
the plurality of fins arranged in a 360 degree direction around a circumference of the battery cell.

6. The system of claim 1, comprising:
each of the plurality of fins having a curved shape corresponding to a shape of the housing of the battery cell.

7. The system of claim 1, comprising:
each of the plurality of fins having a height that is less than a height of the housing of the battery cell.

8. The system of claim 1, comprising:
the plurality of fins extending perpendicular from the first surface of the cooling plate.

9. The system of claim 1, comprising:
the plurality of fins formed from a same material as the cooling plate.

10. The system of claim 1, comprising:
a plurality of pairs of fins extending from the first surface of the cooling plate; and
each of the plurality of pairs of fins spaced a predetermined distance from a neighboring fin along the first surface of the cooling plate.

11. The system of claim 1, comprising:
a plurality of fin arrangements extending from the first surface of the cooling plate in a predetermined pattern;
a plurality of battery cells;
each of the plurality of battery cells coupled with at least one fin arrangement of the plurality of fin arrangements; and
the plurality of battery cells arranged in the predetermined pattern along the first surface of the cooling plate.

12. The system of claim 1, comprising:
a plurality of fin arrangements extending from the first surface of the cooling plate in a predetermined pattern; and
a plurality of battery cells; and
the plurality of battery cells spaced from each other a distance in a range from 0.7 mm to 0.9 mm.

13. The system of claim 1, comprising:
the plurality of fins including an aluminum material.

14. The system of claim 1, comprising:
the sleeve comprises thermally conductive plastic disposed in a 360 degree direction around a circumference of the housing of the battery cell.

15. The system of claim 1, comprising:
the first polarity region forms a first polarity terminal of the battery cell;
the outer gasket comprising a crimped edge that extends over a portion of a first surface of the first polarity region; and
the second polarity region that forms a second polarity terminal of the battery cell.

16. The system of claim 1, comprising:
the battery cell disposed in a battery pack and the battery pack disposed in an electric vehicle.

17. A method of providing heat transfer for battery cells to power an electric vehicle, comprising:
providing a battery pack having a battery cell, the battery cell having a housing that includes a first end and a second end and defines an inner region;
disposing an electrolyte within the inner region of the housing;
forming a lid comprising an outer gasket, a first polarity region, an isolation region, and a second polarity region, the outer gasket coupled with the first polarity region, the isolation region disposed within an inner edge surface of the first polarity region, and an outer edge of the second polarity region coupled with an inner isolation surface of an orifice of the isolation region;
coupling the lid with the first end of the housing;
disposing a sleeve around an outer surface of the housing of the battery cell;
forming a cooling plate having a plurality of fins, and the cooling plate having a first surface and a second surface; and
coupling the battery cell with the first surface of the cooling plate with the plurality of fins disposed around the battery cell and coupled with the sleeve to transfer heat between the battery cell, the plurality of fins and the cooling plate, the plurality of fins extending from the first surface of the cooling plate.

18. The method of claim 17, comprising:
forming a plurality of fin arrangements extending from the first surface of the cooling plate;
disposing each of a plurality of battery cells with at least one fin arrangement of the plurality of fin arrangements along the first surface of the cooling plate, each of the plurality of plurality of fin arrangements having at least two fins coupled with the sleeve around the housing of the battery cell.

19. The method of claim 17, comprising:
forming plurality of fin arrangements extending from the first surface of the cooling plate;
disposing each of a plurality of battery cells with at least one fin arrangement of the plurality of fin arrangements along the first surface of the cooling plate; and
spacing each of the plurality of battery cells a distance in a range from 0.7 mm to 0.9 mm from at least one other battery cell of the plurality battery cells along the first surface of the cooling plate.

20. An electric vehicle, comprising:
a battery cell of a battery pack to power an electric vehicle, the battery cell comprising:
a housing defining an inner region, the housing having a first end and a second end;
an electrolyte disposed within the inner region; and
a lid coupled with the first end of the housing;
the lid comprising an outer gasket, a first polarity region, an isolation region, and a second polarity region, the outer gasket coupled with the first end of the housing and the first polarity region, the isolation region disposed within an inner edge surface of the first polarity region, and an outer edge of the second polarity region coupled with an inner isolation surface of an orifice of the isolation region; and
a sleeve coupled with an outer surface of the housing of the battery cell;
a cooling plate coupled with the second end of the housing of the battery cell, the cooling plate having a first surface and a second surface;
a plurality of fins extending from the first surface of the cooling plate; and
the plurality of fins disposed around the battery cell and coupled with the sleeve to transfer heat between the battery cell, the plurality of fins and the cooling plate.
